(19) United States
(12) Patent Application Publication
(10) Pub. No.: US 2004/0095463 A1
(43) Pub. Date: May 20, 2004

(54) Portable device

(76) Inventor: Tetsutaka Yabuta, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/714,921

(22) Filed: Nov. 18, 2003

(30) Foreign Application Priority Data
Nov. 20, 2002 (JP) 336956/2002
Sep. 9, 2003 (JP) 316708/2003

(51) Int. Cl. H04N 7/18

(52) U.S. Cl. 348/61

(57) ABSTRACT

An operation key is shared between a portable telephone and a television, to reduce the number of keys to minimize an area required for the arrangement of the keys. Particularly, a ten-key is arranged so as to make use of arrangement in a conventional portable telephone and arrangement in a conventional TV remote control and such that a user does not have an uncomfortable feeling. Further, the entry of characters in the same method as that in the portable telephone is allowed, to make it possible to perform entry processing for data broadcasting. Further, only the entry of the name of a program allows in formation related to a channel on which the program is broadcast to be acquired, to make it possible to view and record the program on the channel.

### BACKGROUND OF THE INVENTION

Field of the Invention

The present invention relates to a portable device having the function of receiving TV (Television) broadcasting and the communication function of a telephone or the like.

A representative of portable devices is a portable telephone. The portable telephone generally comprises an antenna 301 for transmitting and receiving a radio telephone signal, a receiving unit 373 for decoding a received signal, a transmission unit 372 for coding a signal to be transmitted, a duplexer 371 for switching transmission and receiving, a speaker 303 for outputting a received audio signal, a display unit 307 for displaying a non-audio signal such as received mail and information required for an operation, a key entry unit 306 composed of keypads used for various types of operations such as response to receiving and calling-out, a transmission operation, a mail operation, and an operation for setting various types of functions, a storage unit 374 for storing various types of information such as information related to a telephone directory and received mail, a microphone 304 for entering an audio to be transmitted, and a control unit 308 for controlling all systems and performing various types of data processing.

On the other hand, the configuration of a television receiver has been generally known and hence, the description thereof is herein omitted. In television broadcasting, however, frequencies or channels which can be received differ for each area, and broadcasting stations to be received must be recorded in correspondence with one-touch keys for respectively selecting the channels. When a television receiving function is arranged in the portable device, however, the television receiver frequently changes its geographical position, so that the channels must be reset in each case.

Therefore, as a portable device having a telephone function and the function of receiving television broadcasting, radio broadcasting, and so on, a device disclosed in JP-A-1996-162909 has been proposed. The device disclosed in the gazette comprises as portable telephone functional units a communication antenna 301, a radio communication control unit 302, a speaker 303, a microphone 304, a communication circuit 381, a key entry unit 306, a display unit 307, and a control unit 308, as shown in FIG. 8. Further, it comprises as broadcasting receiving functional units a one-touch key entry unit 382, a storage unit 309, a TV antenna 310, a broadcasting receiving unit 311, and a broadcasting information output unit 383.

Here, the communication antenna 301 is for performing transmission and receiving in a portable telephone, and the radio communication control unit 302 is for establishing radio communication with a portable telephone base station via the communication antenna 301. Further, the speaker 303 and the microphone 304 are for making telephone calls in the portable telephone.

The communication circuit 381 is a circuit device for allowing telephone calls to be made by the speaker 303 and the microphone 304. Further, the key entry unit 306 is an entry key for setting various types of data for using the portable telephone and entering a telephone number, and is composed of a ten-key, etc. The display unit 307 is a display unit for displaying a telephone number for making a telephone call, and a date, etc.

The control unit 308 serving as frequency searching means, receiving sensitivity judgment means, frequency re-searching means, and another frequency searching means controls the above-mentioned units on the basis of the operations of the key entry unit 306 and the one-touch key entry unit 382. Further, the one-touch key entry unit 382 is operation buttons for tuning in to broadcasting, and is composed of one-touch keys.

Furthermore, the storage unit 309 comprises a position information registration unit 313 serving as position information storage means, a broadcasting station registration unit 314 and a frequency registration unit 315 serving as frequency storage means. The position information registration unit 313 stores position information transmitted from the portable telephone base station, and the broadcasting station registration unit 314 has a correspondence table having a correspondence between the number of the one-touch key in the one-touch key entry unit 382 and the names of broadcasting stations registered therein, as shown in FIG. 9(a).

Here, a “broadcasting station number 1” and a “broadcasting station number 2” in FIG. 9(a) mean that the “broadcasting station number 1” and the “broadcasting station number 2” are respectively a first candidate broadcasting station and a second candidate broadcasting station in the certain key number. The broadcasting station name registered in the broadcasting station registration unit 314 is previously registered, or can be arbitrarily entered by a user.

The frequency registration unit 315 has a correspondence table having a correspondence between a position for receiving and a frequency in a certain broadcasting station registered therein, as shown in FIG. 9(b). The TV antenna 310 is a receiving antenna for receiving a radio broadcasting program, a television broadcasting program, and so on. The broadcasting receiving unit 311 is for receiving a broadcasting program via the TV antenna 310, and performs channel selection or tuning by the control of the control unit

Furthermore, when a power switch (not shown) is turned on, the control unit 308 requires position information of a portable telephone base station (not shown) via the radio communication control unit 302 and the communication antenna 301, and registers the position information returned from the portable telephone base station in the position information registration unit 313 in the storage unit 309.

An example of a method of acquiring position information is a method using a GPS (Global Positioning System), as disclosed in JP-A-2002-325831, in addition to the foregoing method.

In the above-mentioned prior art, when a television receiving function and a telephone function are arranged in the portable device, as disclosed in JP-A-1996-162909, both an operation key for a portable telephone and an operation key for a television are required. However, it is essential for the portable device to be formed in a small size. Accordingly, an area in which the operation keys can be arranged is limited. Therefore, key arrangement for minimizing an area required to arrange the operation keys is required. When key arrangement different from that in the portable telephone is made, the operability of the portable device is degraded for a user who is accustomed to the portable telephone or the like.

### SUMMARY OF THE INVENTION

In view of the foregoing circumstances, an object of the present invention is to provide a portable device capable of also improving its operability for viewing television broadcasting while realizing the same key arrangement as that in a portable telephone to maintain the operability of the portable telephone.

In order to solve the above-mentioned problem, a portable device according to the present invention is characterized by comprising a portable telephone functional unit having a radio transmission/receiving circuit for establishing communication utilizing a radio communication network and a key entry unit composed of a plurality of keys for performing an operation required for the communication; a television broadcasting receiving unit for receiving television broadcasting; and a control unit for controlling the portable telephone functional unit and the television broadcasting receiving unit, and in that the control unit processes a signal from at least one of the keys composing the key entry unit as an operation signal for receiving television broadcasting in a television broadcasting receiving mode (hereinafter referred to as a first configuration in this item).

In the above-mentioned first configuration, the portable device may be so configured that a ten-key for entering the number of the other party in the communication is arranged in the key entry unit, and the control unit processes signals from keys numbered 1 through 9 as information for designating channel positions 1 through 9 and processes signals from a key numbered 10 and a # key and a * key as information for designating channel positions 10 to 12 in the television broadcasting receiving mode.

In the above-mentioned first configuration, the portable device may be so configured that a direction key for selecting each of the functions of a portable telephone is arranged in the key entry unit, and the control unit processes a signal from the direction key as information related to a command for receiving television broadcasting in the television broadcasting receiving mode.

In the above-mentioned configuration, the portable device may be so configured that a ten-key for entering the number of the other party in the communication is arranged in the key entry unit, and the control unit processes a signal from the ten-key as a character designation signal for a correspondence in a character entry mode for non-audio communication in a portable telephone, while processing the signal from the ten-key as a character designation signal related to television broadcasting in a character entry mode related to television broadcasting (hereinafter referred to a second configuration in this item).

In the above-mentioned second configuration, the portable device may be so configured that the control unit processes the signal from the ten-key as a character designation signal for transmission information related to data broadcasting in a data broadcasting receiving mode. Further, in the above-mentioned second configuration, the portable device may be so configured that the control unit processes the signal from the ten-key as information for specifying a program name for receiving television broadcasting, and acquires tuning information related to a program whose name coincides with the specified program name, to perform receiving processing.

In the above-mentioned configuration, the portable device may comprise means for video-recording on a recording medium a video and an audio obtained by receiving television broadcasting. Further, the portable device may comprise a video recording reservation information memory for recording information required to video recording reservation, and means for judging the current date and time, and may be so configured that a reserved program is received and video-recorded when it is judged that the date and time of reservation for receiving has arrived (hereinafter referred to as a third configuration in this item).

In the above-mentioned third configuration, the portable device may be so configured that the control unit displays an information entry menu (an information entry screen) required for video recording reservation and acquires information required for the video recording reservation on the basis of the signal from the key entry unit. Further, in the above-mentioned third configuration, the portable device may be so configured that the control unit sets the information required for video recording reservation in the video recording reservation information memory when it judges that a power key is turned off.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a portable device according to a first embodiment of the present invention;

FIG. 2 is a front view showing the appearance of the portable device;

FIG. 3 is a front view showing another example of the appearance of the portable device;

FIG. 4 is a flow chart showing video recording reservation in the portable device;

FIG. 5 is an explanatory view showing an example of a menu screen in the portable device;

FIG. 6 is an explanatory view showing a timer recording setting menu (a reservation screen) in the portable device;

FIG. 7 is a block diagram of a conventional portable telephone;

FIG. 8 is a block diagram of a portable telephone having a conventional TV receiving function;

FIG. 9 is an explanatory view showing a correspondence table generally used, where FIG. 9(a) is a correspondence table between a one-touch key and broadcasting stations, and FIG. 9(b) is a correspondence table between a position and a broadcasting frequency which correspond to each of broadcasting stations;

FIG. 10 is a block diagram showing a portable device according to a second embodiment of the present invention;

FIG. 11(a) is an explanatory view illustrating a data broadcasting receiving screen of the portable device, and FIG. 11(b) is an explanatory view showing a character entry area in the screen;

FIG. 12 is a flow chart showing processing related to the entry of characters into the character entry area;

FIG. 13 is a flow chart showing up-down channel selection processing in the portable device; and

FIG. 14(a) is an explanatory view showing a window on which an entered channel number is displayed, and FIG. 14(b) is a flow chart showing direct channel selection processing in the portable device.

### DESCRIPTION OF THE PREFERRED EMBODIMENTS

(Embodiment 1)

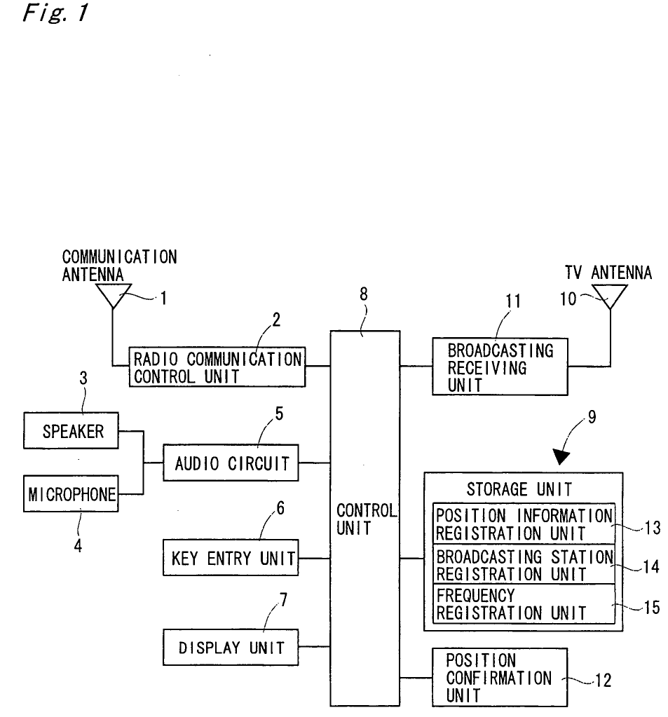

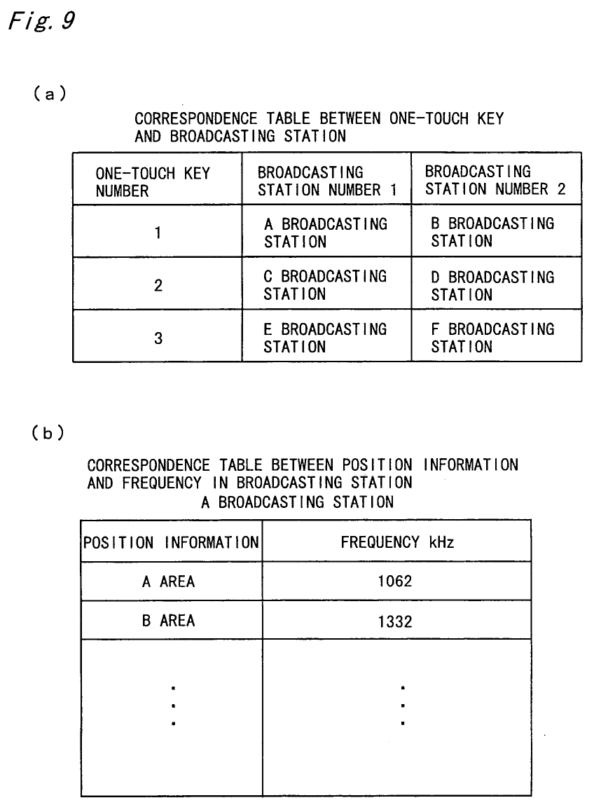

A portable device according to a first embodiment of the present invention will be described on the basis of FIGS. 1 to 6. FIG. 9 shown in the prior art item is herein used again.

FIG. 1 is a block diagram of the portable device according to the present embodiment. The portable device is a portable telephone capable of receiving television broadcasting and can be viewed and video-record the received television broadcasting and reproduce the number of the video-recorded television broadcasting to view the television broadcasting.

As shown in FIG. 1, the portable device comprises a communication antenna 1 connected to a portable telephone network for transmitting and receiving radio waves, a radio communication control unit 2 for decoding a received signal obtained via the communication antenna 1 depending on its communication format, and encoding a signal to be transmitted depending on the communication format to transmit the signal via the communication antenna 1, a speaker 3 for outputting a received audio signal as an audio, a microphone 4 for inputting an audio signal to be transmitted, an audio circuit 5 for converting the received audio signal into one in such a form that it can be outputted from a speaker, and converting the audio signal inputted from the microphone 4 into one in such a form that it is transmittable, a key entry unit 6 serving as an operation unit for using the function of the portable telephone, performing a setting operation of various types of modes, creating mail, and performing various types of terminal operations such as calling-out and response, a display unit 7 for displaying information required for the operations, and a control unit 8 for controlling a terminal system and processing various types of data.

Furthermore, in order to receive television broadcasting, the portable device has a TV antenna 10 for receiving a TV broadcasting signal, and a broadcasting receiving unit 11 for selecting (tuning in to) a desired broadcasting station from the TV broadcasting signal received via the TV antenna 10, and subjecting the received broadcasting signal to demodulation processing. In order to view the received television broadcasting, an image is displayed by the display unit 7, and an audio is outputted by the speaker 3.

The portable device has a storage unit 9 comprising a position information registration unit 13 for storing position information obtained via a position confirmation unit 12, a broadcasting station registration unit 14 for storing a correspondence table between key entry and the names of corresponding broadcasting stations, as shown in FIG. 9(a), and a frequency registration unit 15 for storing a correspondence table between a position where each of the broadcasting stations is receivable and a frequency at the position, as shown in FIG. 9(b). That is, a user operates the key entry unit 6, to enter a selected channel. On the entered selected channel, the actual broadcasting station is recognized by the correspondence table stored in the broadcasting station registration unit 14, and the frequency of the recognized broadcasting station, as described above, at the current position is recognized on the basis of the position information stored in the position information registration unit 13 and the frequency registration unit 15. A channel on which a program to be viewed is broadcast is tuned in to in accordance with the frequency.

Furthermore, the current position information is recorded on the position information registration unit 13 via the position confirmation unit 12. The position confirmation unit 12 can recognize and acquire a communication area at the current position by acquiring the transmission of the position information from a portable telephone base station during communication. Alternatively, the current position information can be also acquired by containing a GPS receiving system and processing a signal from a GPS satellite.

Furthermore, the communication antenna 1 and the TV antenna 10 may be made common and constructed as one antenna.

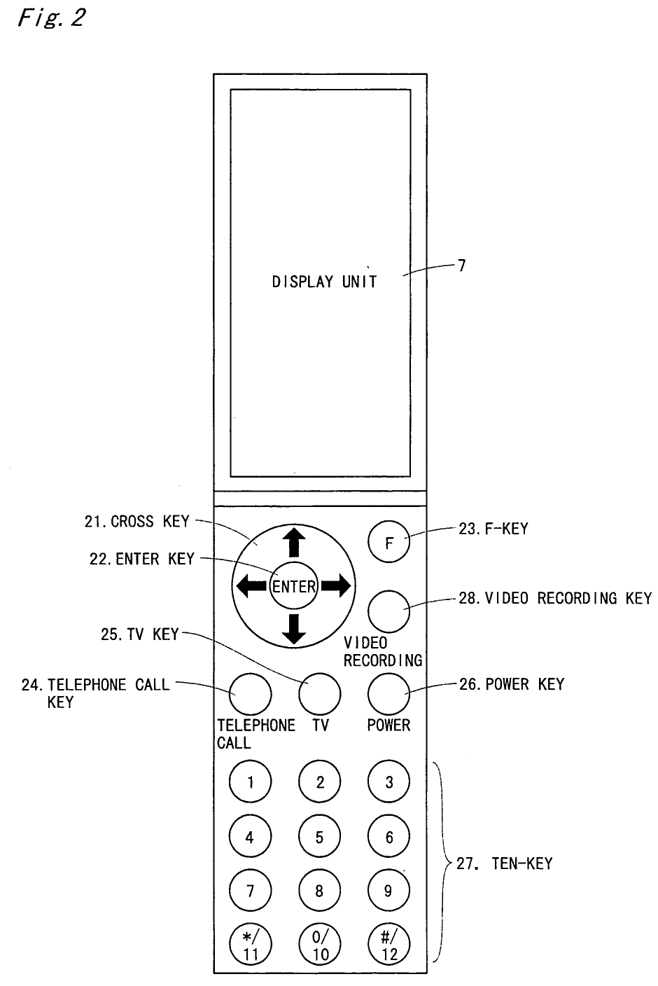

A first example of the arrangement of keys is then shown in FIG. 2. As shown in FIG. 2, the key entry unit 6 comprises a cross key (a direction key) 21, an enter key 22, an F-key 23, a telephone call key 24, a TV key 25, a power key 26, and a ten-key 27. The cross key 21 is a key which is used for moving a cursor upward or downward or rightward or leftward, for example, in performing various types of entry operations and is well-known in a portable telephone. In order to determine an item selected by the cross key 21, the enter key 22 is used. Further, the F-key 23 is used to select various types of functions and read out an operation screen related to the setting of various types of modes. The telephone call key 24 is used in the case of calling-out or in responding to calling-in. When the TV key 25 is pressed, processing for viewing television broadcasting is performed (a television broadcasting receiving mode). The power key 26 is used to turn the power on/off.

The ten-key 27 is used to enter a telephone number in a case where a telephone function is used and to enter characters at the time of creating mail, and such an information entry technique itself is well-known in the field of portable telephones. In the present invention, in order to use the ten-key 27 as a channel key at the time of watching TV and to use the ten-key 27 without having a feeling uncomfortable with the operation of a conventional TV remote control, keys numbered 1 through 9 are allocated to selection channels numbered 1 through 9 as they are. Channel 10, Channel 11, and Channel 12 are respectively arranged in keys 0, *, and #. That is, the control unit 8 processes a signal from the ten-key 27 as an operation signal (a channel selection command signal) for receiving television broadcasting in a television broadcasting receiving mode.

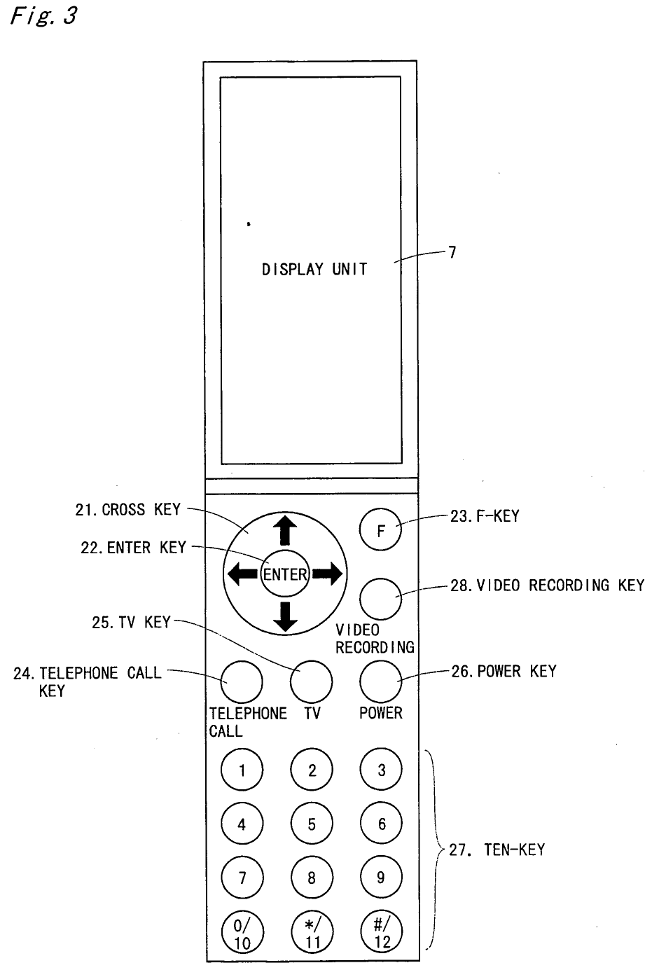

Alternatively, in order to make the arrangement of the keys the same as the arrangement of position keys in a general TV remote control, keys numbered 1 through 9 may be allocated to selection channels numbered 1 through 9 as they are, as shown in FIG. 3. Channel 10, Channel 11, and Channel 12 may be respectively arranged in keys *, 0, and #. That is, Channel 10, Channel 11, and Channel 12 are arranged in the keys *, 0, and #.

The portable device is so configured that a program which is being viewed can be video-recorded by pressing the video recording key 28.

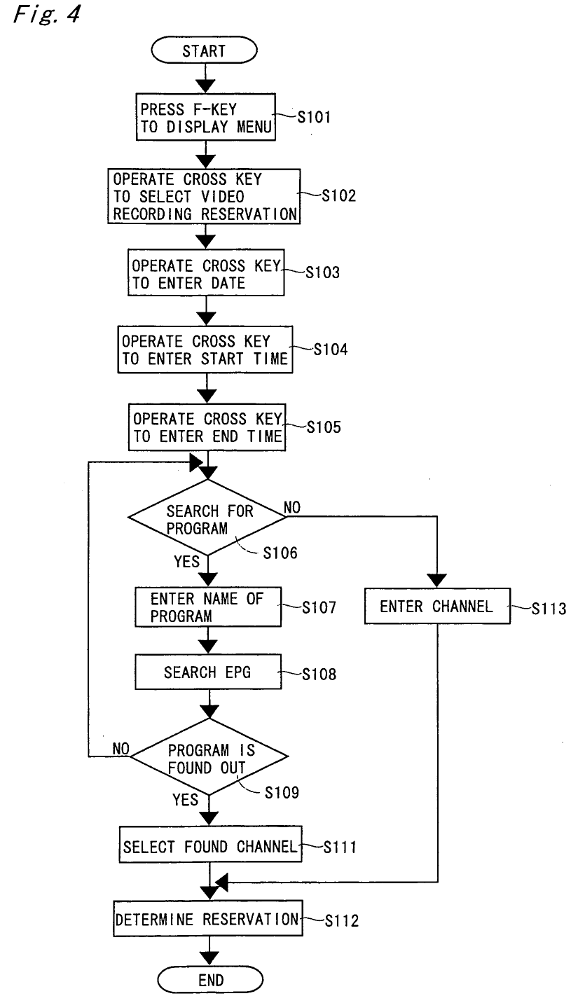

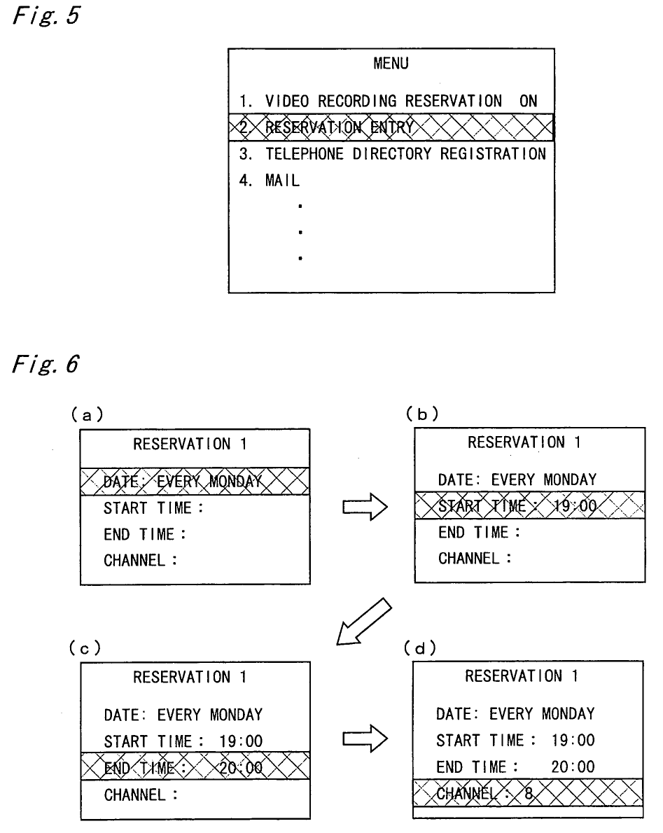

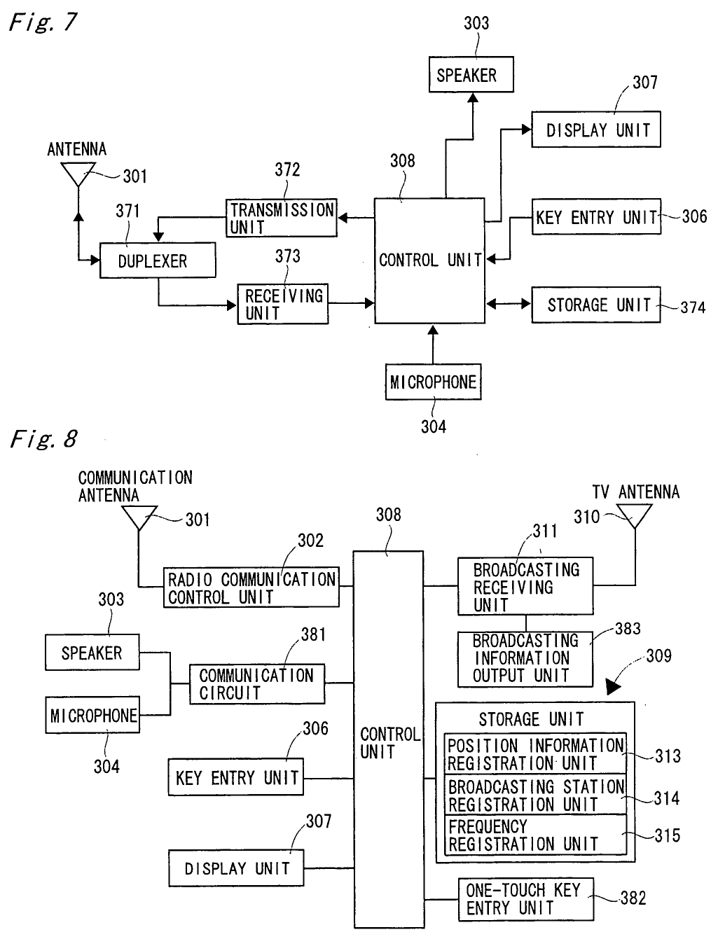

A method of video recording reservation will be then described on the basis of a flow chart of FIG. 4. When the press of the F-key 23 is detected, a menu screen is displayed (step S101). An example of the menu screen is shown in FIG. 5. The user operates the cross key 21, and puts the cursor on “reservation entry”, to press the enter key 22. The operation is detected by the control unit 8, so that the portable device enters a video recording reservation mode. When the portable device enters the video recording reservation mode, the control unit 8 displays a timer recording setting menu on the display unit 7, as shown in FIG. 6 (step S102).

The user operates upward and downward arrow keys in the cross key 21, to select a date item, as shown in FIG. 6(a). When the user presses rightward and leftward arrow keys in the cross key 21, the dates are displayed in the order starting with the current day. If the rightward arrow key is pressed, for example, the dates for one month are sequentially displayed. Thereafter, every day, every Monday, every Tuesday, every Wednesday, every Thursday, every Friday, every Saturday, every Sunday, from Monday to Friday, and from Monday to Saturday are displayed, and the current day is displayed again. That is, the control unit 8 performs, after it detects that the date item is selected, processing for displaying a day of the week in order to cause the user to select the day of the week on the basis of a signal for operating the cross key 21. The user presses the enter key 22 when the desired date is displayed (step S103). The control unit 8 temporarily registers information related to the day of the week in a case where the enter key 22 is pressed (maintains a state where the day of the week is displayed). When the leftward arrow key is operated, the dates are displayed in the order reverse to the foregoing order.

When the enter key 22 is pressed with respect to the day of the week, as described above, the control unit 8 moves the cursor to a start time item, as shown in FIG. 6(b). The user operates the rightward and leftward arrow keys in the cross key 21, to change a start time. Specifically, times are changed in ascending order by the rightward arrow key, while being changed in descending order by the leftward arrow key. Therefore, the enter key 22 is pressed when the desired time is displayed, as in the above-mentioned case of the date, to determine a start time (step S103). That is, the control unit 8 performs processing for changing the displayed time on the basis of information related to the operation of the cross key 21 when the cursor is positioned at the start time item, while temporarily registering the displayed time (maintaining a state where the start time is displayed) when it detects that the enter key 22 is pressed.

When the enter key 22 is pressed with respect to the start time, as described above, the control unit 8 moves the cursor to an end time item, as shown in FIG. 6(c). The user operates the rightward and leftward arrow keys in the cross key 21, to determine an end time. Specifically, times are changed in ascending order by the rightward arrow key, while being changed in descending order by the leftward arrow key. Therefore, the enter key 22 is pressed when the desired time is displayed, as in the above-mentioned case of the start time, to determine an end time (step S105). That is, the control unit 8 performs processing for changing the displayed time on the basis of information related to the operation of the cross key 21 when the cursor is positioned at the end time item, while temporarily registering the displayed time (maintaining a state where the end time is displayed) when it detects that the enter key 22 is pressed.

When the enter key 22 is pressed with respect to the end time, as described above, the control unit 8 moves the cursor to a channel item, as shown in FIG. 6 (d). The user presses, when he or she finds a channel on which a desired program is broadcast (NO in step S106), the ten-key 27 to select the channel, and presses the enter key 22, to determine the channel (step S113).

On the other hand, the user enters, when he or she does not find the channel on which the desired program is broadcast (YES in step S106), characters using the ten-key 27, and presses the enter key 22, to specify the name of the desired program (step S107). That is, the control unit 8 processes a signal from the ten-key 27 as information for specifying a program name for receiving television broadcasting. In the present embodiment, the control unit 8 searches using an EPG (Electronic Program Guide) for a channel to which a program whose name coincides with the specified program name is broadcast belongs (step S108) When the channel on which the program is broadcast is not found out, the program is searched for again (YES in step S106, step S107, and step S108). Alternatively, the user finds out a channel, to enter the channel (step S113). When the channel on which the desired program is broadcast is found out (YES in step S109), the number of the channel is displayed, as shown in FIG. 6(d), and the user presses the enter key 22, to determine the channel (step S111).

Video recording reservation is set on the basis of the contents of the determined reservation, as described above (step S112). That is, the control unit 8 records in a reservation memory information for specifying a channel on which a program whose video recording reservation has been determined is broadcast and the date and time of reservation for receiving. Various methods are considered as a method of setting the video recording reservation. For example, the power is turned off by pressing the power key 26, to set video recording reservation. That is, the control unit 8 sets in a video recording reservation information memory a channel on which a program to be an object of video recording reservation is broadcast and the date and time of reservation for receiving when it judges that a power key is turned off. In this method, a telephone call is not accepted while the video recording reservation is being set, thereby not preventing video recording.

Furthermore, various methods are considered as another method of setting video recording reservation. For example, the TV key 25 and the video recording key 28 are simultaneously pressed. Alternatively, the video recording key 28 is pressed for a long time. Further, video recording reservation may be settable from a menu by operating the F-key 23, as in a video recording reservation item shown in FIG. 5.

In a case where there occurs a state where video recording reservation is set even if the power is turned off by pressing the power key 26, energization to the control unit 8, for example, is maintained. The control unit 8 comprises a calendar function for judging the current date and time, and performs, when it judges that the date and time of reservation for receiving has arrived, tuning processing for receiving a reserved program, performs energization to a memory for video recording, subjects a video and an audio in the received program to A/D (Analog-to-Digital) conversion, and records the converted video and audio on the memory.

(Embodiment 2)

When data broadcasting for terrestrial wave digital broadcasting involves character entry, the characters are entered utilizing a character entering method for a portable telephone. Specifically, the portable telephone has conventionally had a character entering function such as mail creation, the character entering function of the portable telephone is applied to a data broadcasting operation for digital broadcasting. For example, the character entering function of the portable telephone is such a system that numeric keys are allocated to alphabetic characters (“A, B, C” is allocated to a “1” key, and “D, E, F, etc.” is allocated to a “2” key), and characters are selected by a repetitive operation of the numeric keys. For example, “A” is selected by first pressing the “1” key, and “B, C, A, . . . ” are then cyclically selected every time the “1” key is pressed.

In terrestrial wave digital broadcasting, the allocation of a broadcasting station to a channel (frequency) differs depending on areas. Consequently, the movement of the portable device causes situations where a program which is being viewed at a certain point is broadcast on a different channel in another point. In the present invention, therefore, a program to be viewed and a broadcasting station (a channel) on which the program is broadcast are entered by characters, and a channel search is made depending on the entry of the characters to perform automatic channel selection. This is the same as the processing in the step S106 to the step S111 in the above-mentioned video recording reservation shown in FIG. 4. Even in watching normal analog TV, a desired program can be also searched for and viewed by the same operation.

In terrestrial wave digital broadcasting, the allocation of a broadcasting station to a channel (frequency) differs depending on areas, as described above. Therefore, channel setting must be changed depending on the position on each occasion. Therefore, channel setting may be automatically changed by making a channel search at regular intervals, for example, intervals of one minute. Alternatively, channels may be set utilizing a correspondence table between position information and channel setting, as disclosed in Japanese Patent Application No. 2002-302062 and Japanese Patent Application No. 2002-325831. A specific example is a method of storing in a memory data representing a correspondence between a state where a broadcasting wave is received and position information during traveling utilizing a car navigation system or a method of each vehicle transmitting the data representing the correspondence to a server by radio communication and receiving from the server correspondence data obtained by another vehicle.

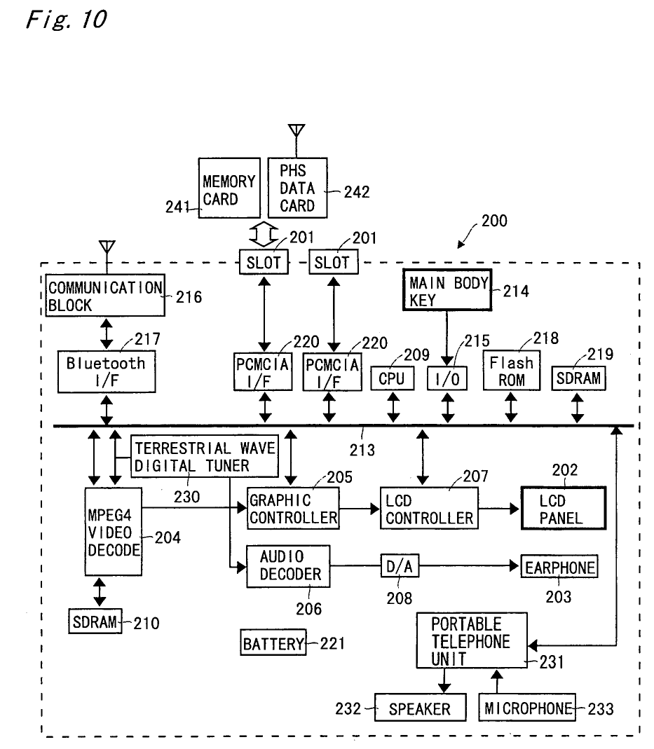

Description is now made of the configuration of a portable broadcasting receiver that receives terrestrial wave digital broadcasting on the basis of FIG. 10. A portable digital broadcasting receiver 200 receives terrestrial wave digital broadcasting using a terrestrial wave digital tuner 230. Further, coded video/audio data are read out of a memory card 241 inserted into a slot 201, to display a video on a liquid crystal display panel 202 as well as to output an audio from an earphone 203.

An MPEG4 (Moving Picture Expert Group4) bit stream data stored in the memory card 241 is fed to an MPEG4 video decoder 204 via a PCMCIA (Personal Computer Memory Card International Association) interface 220 and a system bus 213. Further, the tuner 230 for receiving terrestrial wave digital broadcasting extracts the bit stream data based on MPEG4, for example, which is broadcast in the terrestrial wave digital broadcasting, and feeds the extracted bit stream data to the MPEG4 video decoder 204 and an audio decoder (MPEG2-AAC) 206 and feeds the extracted bit stream data to the system bus 213 in order to record the bit stream data on the memory card 241. The MPEG4 video decoder 204 decodes the bit stream data to find a quantization factor and a motion vector, and feeds to a graphic controller 205 video data obtained by performing inverse DCT conversion, motion compensation control based on a motion vector, and so on. The graphic controller 205 subjects video data (e.g., R, G, and B data) to processing such as color control. Further, the graphic controller 205 also performs processing for on-screen displaying characters, etc. (an operation button, a menu screen, an EPG screen based on program information acquired from terrestrial wave digital broadcasting, etc.) which it is instructed to output from a CPU 209. The audio decoder 206 decodes coded audio data in a bit stream, to generate audio data. An SDRAM (Synchronous Dynamic RAM) 210 is utilized in the above-mentioned processing of the MPEG4 video decoder 204.

An LCD (Liquid Crystal Display) controller 207 drives the liquid crystal display panel 202 on the basis of the video data fed from the graphic controller 205. Further, a D/A (Digital-to-Analog) converter 208 receives the audio data outputted from the audio decoder 206 to subject the received audio data to D/A conversion, and generates an analog signal of a right (R) sound and an analog signal of a left (L) sound to feed the generated analog signals to the earphone 203.

A main body key 214 has the same structure as the key structure shown in FIGS. 2 and 3 (the cross key 21, the enter key 22, the F-key 23, the telephone call key 24, the TV key 25, the power key 26, the ten-key 27, the video recording key 28, etc.). Operation information for the main body key 214 is fed to the CPU 209 via an interface 215 and the system bus 213. The CPU 209 performs required processing on the basis of the above-mentioned operation information.

In order to allow a radio network, a communication block 216 and an interface 217 are provided. Further, there are also provided a Flash ROM 218 and an SDRAM 219. A battery 221 is a secondary battery, and obtains the supply of power from a charger (not shown) and stores the obtained power. A portable telephone unit 231 shall be used for normal telephone calls or mail. A speaker 232 and a microphone 233 are connected to the portable telephone unit 231.

The CPU 209 performs processing for a radio network, data transmission and receiving in a case where a PHS (Personal Handyphone System) data card 242 is mounted on a slot 201, control of each functional unit based on received data, read/write control of the Flash ROM 218 and the SDRAM 219, and so on.

Items “main menu”, “watch TV”, “reproduce”, etc. are displayed as a menu screen, for example, on the liquid crystal display panel 202. When the item “watch TV” is selected, the tuner 230 is controlled in order to receive a program on a channel designated by user's entry, to display the program on the basis of acquired bit stream data related to the program. The items can be selected by operating the cross key 21, for example, as described above. Further, when the item “reproduce” is selected, a list of programs which have already been recorded is displayed. The list of programs comprises a program name, a channel number, a date of recording, etc. When the user operates the cross key 21 to put the cursor on a desired program portion and press the enter key 22, reproduction processing is performed.

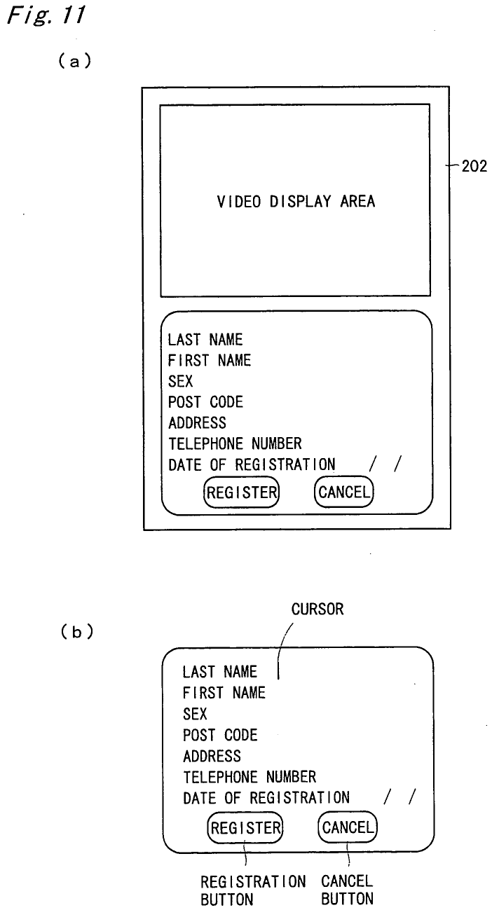

A processing performed by the CPU 209 will be further described. First, description is made of a method of entering text in data broadcasting. In the data broadcasting, video data and text data can be received. In this case, a video is displayed utilizing an upper half area of the LCD panel 202, and a text screen can be displayed utilizing a lower half area of the LCD panel 202, as shown in FIG. 11(a). In FIG. 11(a), a user registration screen is illustrated as the text screen. The user enters text using the main body key 214.

Here, on a registration screen in conventional data broadcasting, a stationary large-screen television set is kept in mind, to display a 50-character kana board on the screen, position a cursor on a desired character by a cross key, and enter characters one at a time while selecting the character by an enter key (such entry is made in a registration screen of data broadcasting on BS-1 (NHK), for example).

Contrary to this, in the portable device according to the present invention, text can be entered using the main body key 214 (the character entering function of the portable telephone can be used), and a plurality of characters can be easily entered. Therefore, the operability of the portable device is made better, as compared with that in the conventional method.

As a specific entering method, characters can be entered into the item on which the cursor is displayed, as shown in FIG. 11(b). The cursor is moved by operating the cross key, so that a frame in which characters are to be entered is changed.

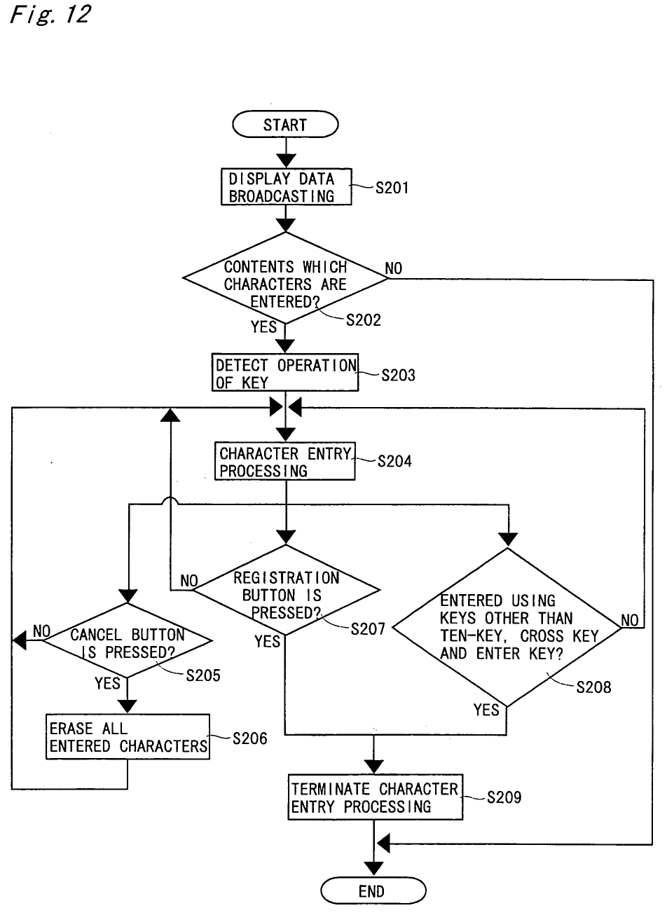

A flow chart of the entry of text is shown in FIG. 12. When data broadcasting is displayed (step S201) it is judged whether or not the data broadcasting has contents in which characters are entered (step S202). In data broadcasting, a BML (Broadcast Makeup Language) file, for example, is transmitted. The CPU 209 (a browser) can make the above-mentioned judgment depending on whether or not there exists description for character entry in the BML file. When the data broadcasting has contents in which characters are not entered, the processing is terminated. On the other hand, when it is judged that the data broadcasting has contents in which characters are entered, the CPU 209 detects the operation of the main body key 214 (step S203), and performs character entry processing (step S204).

When the CPU 209 detects that the enter key 22 is pressed in a state where the cursor is put on a “Cancel” button on the screen (YES in step S205), it erases data representing entered characters (step S206), after which the procedure is returned to the step S204. On the other hand, the CPU 209 terminates character entry processing (step S209) in a case where it detects that the enter key 22 is pressed in a state where the cursor is put on a “Register” button on the screen (YES in step S207), while continuing to perform processing after the procedure is returned to the step S204 in the other case (No in steps S205 and S207). Further, when characters are entered using keys other than the cross key 21, the enter key 22, and the ten-key 27 (YES in step S208), the entry of characters is terminated (step S209).

The following three methods are considered as a method of tuning in to a television. The first method is a method of performing channel selection by previously allocating services (channels), respectively, to the keys composing the ten-key 27, and pressing a button (one-touch channel selection), the second is a method of performing channel selection using channel number up and down keys (up-down channel selection), and the third method is a method of performing channel selection by directly designating a two-digit or three-digit number utilizing the ten-key 27 (direct channel selection). The portable device according to the present embodiment shall correspond to the above-mentioned three channel selecting methods. Judgment which of the channel selecting methods (channel selection modes) should be selected may be previously registered on a menu screen, for example.

The above-mentioned first channel selecting method is as described in the embodiment 1.

In the above-mentioned second channel selecting method, keys, corresponding to channel number up and down arrow keys in the remote control, shall be respectively allocated to keys (e.g., up and down keys in the cross key) in the portable telephone. When the up key (up arrow key) is pressed, a channel succeeding a channel currently selected is selected. Conversely, when the down key (down arrow key) is pressed, a channel preceding the channel currently selected is selected. The transition between channels selected by the up and down keys occurs in a sequence conforming to a correspondence table between a ten-key and broadcasting service (see FIG. 9(a)). The above-mentioned succeeding channel means the channel corresponding to the ten-key having the next largest numerical value, shown in the table. Similarly, the above-mentioned preceding channel means the channel corresponding to the ten-key having the next smallest numerical value, shown in the table.

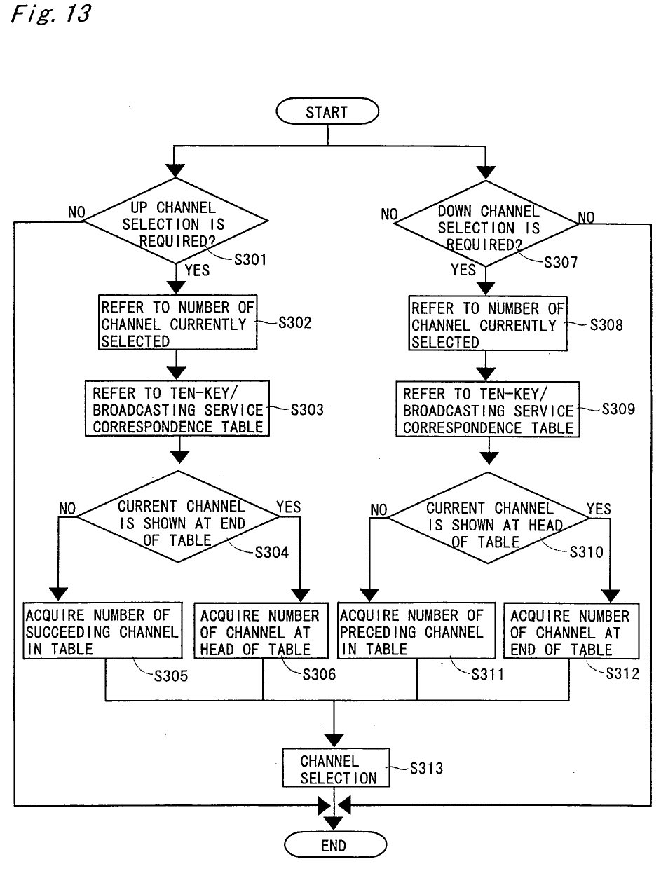

A flow chart of up-down channel selection is shown in FIG. 13. When the up channel selection is requested (the up key is pressed) (YES in step S301), the number of a channel currently selected is referred to (step S302). Further, the ten-key/broadcasting service correspondence table is referred to (step S303), and it is judged whether or not the current channel is recorded at the end of the table (step S304). Unless the current channel is recorded at the end of the table, the number of a succeeding channel in the table is acquired (step S305), after which the procedure proceeds to the step S313. On the other hand, if the current channel is recorded at the end of the table, the number of a channel at the head of the table is acquired (step S306), after which the procedure proceeds to the step S313.

When the down channel selection is requested (the down key is pressed) (YES in step S307), the number of a channel currently selected is referred to (step S308). Further, the ten-key/broadcasting service correspondence table is referred to (step S309), and it is judged whether or not the current channel is recorded at the head of the table (step S310). Unless the current channel is recorded at the head of the table, the number of a preceding channel in the table is acquired (step S311), after which the procedure proceeds to the step S313. On the other hand, if the current channel is recorded at the head of the table, the number of a channel at the end of the table is acquired (step S312), and channel selection is performed on the basis of the acquired channel number (step S313).

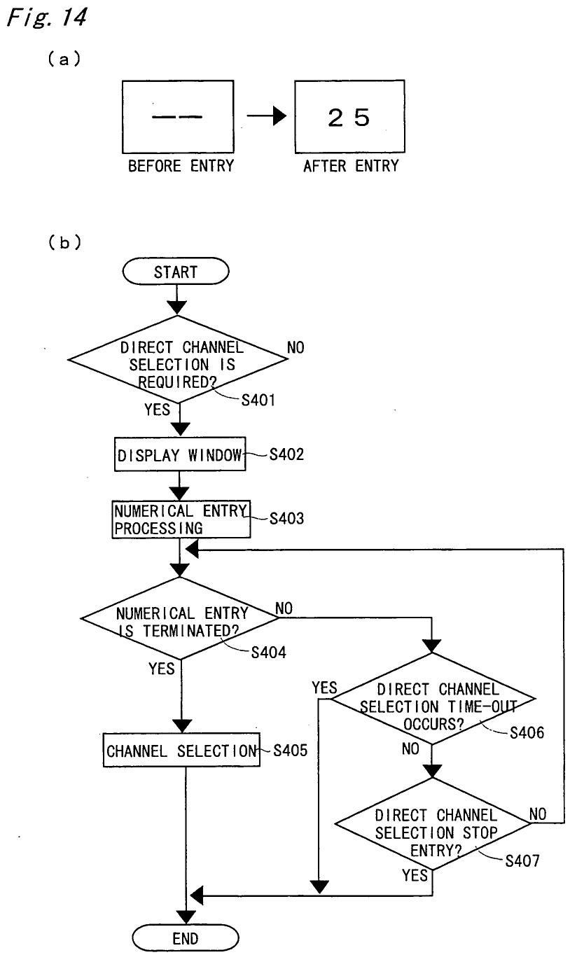

In the above-mentioned third channel selecting method, a window for entering a two-digit or three-digit channel number by pressing the TV key 25, for example (see FIG. 14(a)) is displayed at a lower right position or the like in the LCD panel 202. An arbitrary two-digit or three-digit number is entered using the ten-key, thereby selecting a channel having the entered number.

A flow chart of direct channel selection is shown in FIG. 14(b). It is herein assumed that a three-digit number must be entered. When the CPU 209 detects that the TV key 25 is pressed in a state where a direct channel selection mode is previously set (YES in step S401), the window is displayed on the screen (step S402) The CPU 209 performs numerical entry processing upon receipt of a signal from the ten-key 27 operated by the user (step S403), and judges whether or not the numerical entry is terminated (step S404). Judgment whether or not the numerical entry is terminated is made when the three-digit number is entered. When it is judged that the numerical entry is terminated, channel selection is performed on the basis of the entered number (step S405). When it is judged that the numerical entry is not terminated (NO in step S404), it is judged whether or not a direct channel selection time-out occurs (step S406). When it is judged that the direct channel selection time-out occurs, the processing is terminated. When it is judged that the direct channel selection time-out does not occur (NO in step S406), it is judged whether or not there is direct channel selection stop entry (step S407). When there is direct channel selection stop entry, the processing is terminated. When it is judged that there is no direct channel selection stop entry (NO in step S407), the procedure is returned to the step S404. The direct channel selection stop entry occurs when the keys other than the ten-key 27 are operated, for example.

The present invention is directed to a portable device comprising a radio communication processing circuit connectable to a radio communication network, a portable telephone functional unit having a key entry unit composed of a plurality of keys for performing an operation required for radio communication, and a television broadcasting receiving unit for receiving television broadcasting, and in which both entry means for operating the portable telephone functional unit and entry means for receiving television broadcasting are allocated to at least one of the keys composing the key entry unit.

Consequently, the key for operating the portable telephone and the key for operating the television are made common, thereby making it possible to minimize an area required to arrange the keys. Therefore, it is easily feasible to miniaturize the portable device.

The present invention can be so configured that the key entry unit comprises at least a ten-key, the ten-key has a number entry function required to establish radio communication and a channel selection function for receiving television broadcasting, channel positions 1 through 9 are respectively arranged in keys numbered 1 through 9, and channel positions 10 to 12 are arranged in a key numbered 0 and a # key and a * key.

Furthermore, the portable device can be also so configured that the key entry unit comprises at least a cross key used for selecting each of the functions of the portable telephone, and the cross key is usable in order to select a function required to receive television broadcasting and set conditions. Specifically, the portable device can be so configured that the key entry unit has a video recording function and a video recording reservation function, and reserved information can be entered using the cross key. Further, it can be also so configured that video recording reservation is set by turning the power key off.

Consequently, the portable telephone can be operated, just as the conventional portable telephone is employed and at the same time, an operation related to a television can be also performed similarly-to the conventional remote control operation. Therefore, the user can watch TV by the same operating method as before without having any uncomfortable feeling.

Furthermore, in the present invention, the portable device can be so configured that entered characters are allocated to the ten-key in order to enter characters required for non-audio communication in the portable telephone, and characters required to receive television broadcasting can be entered in the same method as the character entry method in the portable telephone. Specifically, the portable device can be also so configured that it is possible to not only enter characters required to receive television broadcasting using the ten-key but also enter the name of a program using the ten-key to obtain broadcasting information related to the entered program.

Even when a channel on which the same program is broadcast differs depending on areas, therefore, it is possible to search for a channel on which a desired program is broadcast only by designating the name of the program, to set video recording reservation on the channel and view the program.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A portable device comprising:
a portable telephone functional unit having a radio transmission/receiving circuit for establishing communication utilizing a radio communication network and a key entry unit composed of a plurality of keys for performing an operation required for said communication;
a television broadcasting receiving unit for receiving television broadcasting; and
a control unit for controlling said portable telephone functional unit and the television broadcasting receiving unit,
said control unit processing a signal from at least one of the keys composing said key entry unit as an operation signal for receiving television broadcasting in a television broadcasting receiving mode.

2. The portable device according to claim 1, wherein
a ten-key for entering the number of the other party in the communication is arranged in said key entry unit, and
said control unit processes signals from keys numbered 1 through 9 as information for designating channel positions 1 through 9 and processes signals from a key numbered 10 and a # key and a * key as information for designating channel positions 10 to 12 in the television broadcasting receiving mode.

3. The portable device according to claim 1, wherein
a direction key for selecting each of the functions of a portable telephone is arranged in said key entry unit, and
said control unit processes a signal from said direction key as information related to a command for receiving television broadcasting in the television broadcasting receiving mode.

4. The portable device according to claim 1, wherein
a ten-key for entering the number of the other party in the communication is arranged in said key entry unit, and
said control unit processes a signal from said ten-key as a character designation signal for a correspondence in a character entry mode for non-audio communication in a portable telephone, while processing the signal from said ten-key as a character designation signal related to television broadcasting in a character entry mode related to television broadcasting.

5. The portable device according to claim 4, wherein
said control unit processes the signal from said ten-key as a character designation signal for transmission information related to data broadcasting in a data broadcasting receiving mode.

6. The portable device according to claim 4, wherein
said control unit processes the signal from said ten-key as information for specifying a program name for receiving television broadcasting, and acquires tuning information related to a program whose name coincides with the specified program name, to perform receiving processing.

7. The portable device according to claim 1, further comprising
means for video-recording on a recording medium a video and an audio obtained by receiving television broadcasting.

8. The portable device according to claim 7, further comprising
a video recording reservation information memory for recording information required for video recording reservation, and
means for judging the current date and time,
a reserved program being received and video-recorded when it is judged that the date and time of reservation for receiving has arrived.

9. The portable device according to claim 8, wherein
said control unit displays an information entry menu required for video recording reservation and acquires information required for the video recording reservation on the basis of the signal from said key entry unit.

10. The portable device according to claim 8, wherein
said control unit sets the information required for video recording reservation in the video recording reservation information memory when it judges that a power key is turned off.
